(19) United States
(12) Patent Application Publication
(10) Pub. No.: US 2008/0250413 A1
(43) Pub. Date: Oct. 9, 2008

(54) Method and Apparatus for Managing Tasks

(75) Inventor: Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,590

(22) PCT Filed: Nov. 3, 2006
(86) PCT No.: PCT/IB06/54080

§ 371 Date: May 5, 2008

(30) Foreign Application Priority Data
Nov. 8, 2005 (CN) 200510120022.2

(51) Int. Cl. G06F 9/48; H04L 12/28

(52) U.S. Cl. 718/102

(57) ABSTRACT

The method of managing a task provided by the present invention includes the steps of decomposing said task into at least two sub-tasks; assigning said at least two sub-tasks to at least two function modules, so that said at least two function modules respectively complete said at least two sub-tasks, wherein said at least two function modules respectively belong to at least two different equipments. By means of the present invention, a virtual equipment can be constructed more flexibly to complete specific tasks, thus not only the resources of the equipments can be made use of more effectively, but also the user's requirements at different situations can be met.

### FIELD OF THE INVENTION

This invention relates to a method and apparatus for managing tasks, in particular to a method and apparatus for managing tasks on the equipment having function sharing module.

### BACKGROUND OF THE INVENTION

The users could connect/combine equipments with different functions in wired or wireless manners at present, so that they could jointly complete a specific task or achieve a specific function. For example, by connecting an MP3 player to an active sound box, the user could have the audio signal sent by the MP3 player played by said active sound box.

Similarly, by means of the current UPnP (Universal Plug and Play) technique, the user could detect the device that is newly connected to the network and that supports the UPnP, and could automatically set it into the available state, so that the user could use a computer to control the household appliances like the refrigerator, the micro-wave oven and the washing machine, thus to effectively make use of the function of each of different appliances.

With the development of wireless transmission technology, the user could wireless connect equipments with different functions in different situations more conveniently, for example, the UWB (Ultra Wide-Band) transmission technique is suitable for short distance and high speed wireless communication, and the user could connect/combine several different equipments through the UWB so as to make them jointly complete a specific task or achieve a specific function.

However, sometimes, the user may only want to use a certain part or a certain single function of one equipment instead of all the functions of said equipment. For example, if the user forgot to take the ear-phone of the MP3 player on the way, so he wants to use the loudspeaker of the cell phone carried with him to play the audio signal sent by the MP3 player; or when the user uses the MP3 player having the function of a radio to listen to the broadcast, the decoding function of the MP3 player will be in the idle state, but the user cannot use the decoding function of said MP3 player to accomplish other tasks at the same time.

In addition, with the development of information technology, one user or family has more and more electronic equipments, each having many different functions, so these equipments have to be effectively organized together to complete the task required by the user. Therefore, there is the need to provide a method and apparatus for managing tasks that is more flexible and could effectively make use of the equipment resources.

### OBJECT AND SUMMARY OF THE INVENTION

The present invention provides a method and apparatus for managing tasks which could enable the user to combine different equipments more flexibly, and could effectively make use of the equipment resources.

A method of managing a task according to the present invention, including the steps of decomposing said task into at least two sub-tasks; assigning said at least two sub-tasks to at least two functional modules, so that said at least two functional modules complete said at least two sub-tasks, respectively, wherein said at least two functional modules respectively belong to at least two different equipments.

An apparatus of managing a task according to the present invention, comprising: a task decomposing unit for decomposing said task into at least two sub-tasks; a task assigning unit for assigning said at least two sub-tasks to at least two functional modules, so that said at least two functional modules complete said at least two sub-tasks, respectively, wherein said at least two functional modules respectively belong to at least two different equipments.

In summary, the method and apparatus for managing a task as provided by the present invention could more flexibly construct a virtual equipment so as to complete a specific task. They could not only make use of the resources of the equipments more effectively, but also meet the user's requirements at different occasions.

The other objects and achievements of the present invention will be made apparent by the following descriptions with reference to the figures and the claims, and a comprehensive understanding could be made on the present invention.

### BRIEF DESCRIPTION OF THE FIGURES

FIG. 1 is the schematic drawing of the structure of an equipment having function sharing module according to one embodiment of the present invention.

FIG. 2 is the schematic drawing of the structure of an equipment having function sharing module and task managing unit according to one embodiment of the present invention.

FIG. 3 is the schematic drawing of the structure of a task managing unit according to one embodiment of the present invention.

FIG. 4 is a flow chart of the method for a device to actively looking for the function sharing module according to one embodiment of the present invention.

FIG. 5. is a flow chart of the method for a device to passively receive the request for function sharing according to one embodiment of the present invention.

FIG. 6 is a flow chart of the method for a task managing unit to look for the function sharing module so as to complete a task according to one embodiment of the present invention.

In all these figures, the same signs indicate the same or similar or corresponding features or functions.

### DETAILED DESCRIPTIONS OF THE INVENTION

The preferred embodiments of the present invention will be described in detail in conjunction to the figures in the following text.

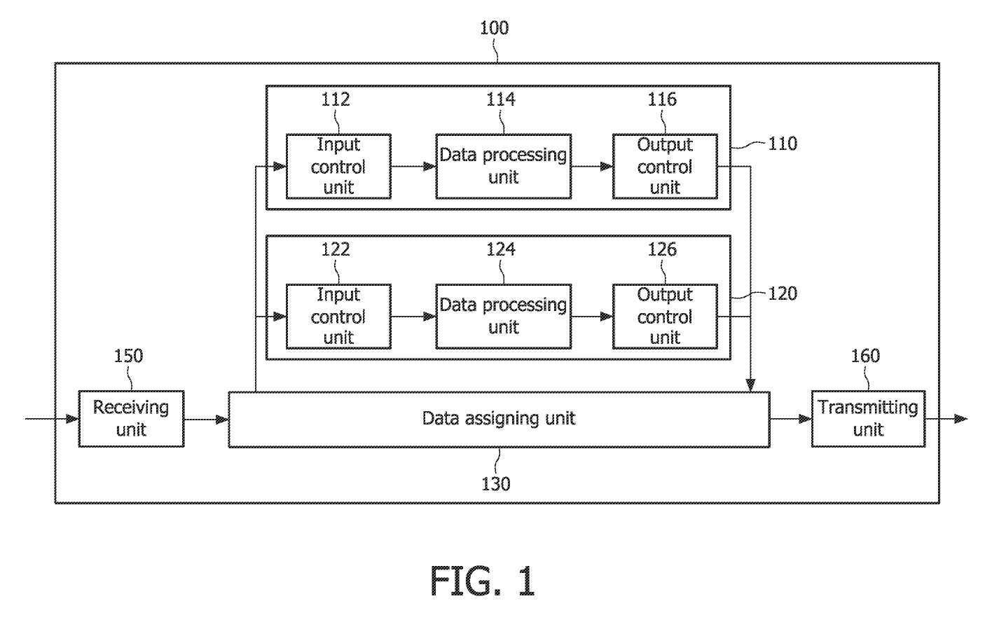

FIG. 1 is the schematic drawing of the structure of an equipment having function sharing module according to one embodiment of the present invention.

According to one embodiment of the present invention, said equipment is an electronic device for completing a certain one or several relevant tasks, for example, an MP3 player or a cell phone, etc. Said function sharing module is a unit in said equipment that could carry out a certain function (e.g., the audio decoding function of an MP3 player), wherein said unit also has functions that could be shared by other equipments.

Said equipment 100 may comprise one or a plurality of function sharing modules, while according to one embodiment of the present invention, said equipment 100 comprises two function sharing modules 110 and 120.

Wherein, function sharing module 110 includes an input control unit 112, a data processing unit 114 and an output control unit 116.

Data processing unit 114 is used as a function module having the function of data processing in the equipment 100. For example, data processing unit 114 could be a part of the program, which could carry out a certain function or relevant function; the data processing unit 114 could also be an independent and identifiable program unit, which could be separately compiled, or be combined with other program units and be loaded into the internal memory of a computer; the data processing unit 114 could also be an assembled hardware functional component designed to be used together with other components, for example, an audio decoding module or an audio playing module, etc. in the MP3 player.

Said data processing unit 114 can receive data of a specific format (e.g., an encoded audio stream data), and correspondingly process data of said format (e.g., decoding the encoded audio stream data), so as to obtain an output data (e.g., a decoded audio data).

Said input control unit 112 is the interface for data processing unit 114 to receive data of a specific format, which may include the input task/sub-task description information of said data processing unit 114 (e.g., said task/sub-task description information including the format description information of an encoded audio stream data); said output data control unit 116 is the interface for data processing unit 114 to output data of a specific format, which may include the output task/sub-task description information of said data processing unit 114 (e.g., the format description information of a decoded audio data).

For instance, said input task/sub-task description information and output task/sub-task description information can be represented in the following manner:

```
Format description {
    Data type; //audio, video, etc.
    Format type; //LPCM, MP3 etc.
    Format specific information; //data length, data rate etc.
}
```

According to one embodiment of the present invention, said task/sub-task description information includes data type (e.g., audio, video, etc.), format type (e.g., LPCM (Linear Pulse-Code Modulations), MP3, etc.) and format description information (e.g., data length, data ratio, etc.) and so on.

According to another embodiment of the present invention, the data processing unit 114 could also include a plurality of input control unit or a plurality of output control unit so as to correspond to different data input or output formats.

Similarly, another functional sharing module 120 also includes an input control unit 122, a data processing unit 124 and an output control unit 126. Since it has the same structure as function sharing module 110, it will not be described in detail any more.

According to one embodiment of the present invention, equipment 100 further comprises a data assigning unit 130 which is connected in parallel to said two function sharing modules 110 and 120, and is used for, according to the information input by a user or a received sharing request, selecting a function sharing module that matches said information input by the user or said sharing request from said equipment 100.

The data assigning unit 130 judges whether a function sharing module matches the received sharing request according to a description file of all the available function sharing modules in said equipment 100. Said description file includes information of all the function sharing modules in said equipment 100, like the names, the description information of input data format, the description information of output data format, and the corresponding availability. Said description file can be stored in a storage unit (not shown) of the equipment 100.

According to one embodiment of the present invention, said equipment 100 further comprises a receiving unit 150 and a transmitting unit 160. When equipment 100 is a part of a home network, the receiving unit 150 and the transmitting unit 160 can be any wired/wireless communications unit of said home network structure.

The receiving unit 150 is connected to the data assigning unit 130, for receiving a sharing request from other equipments. Said sharing request includes task/sub-task description information so as to enable the data assigning unit 150 to judge, according to said task/sub-task description information, whether the data processing function of the function sharing modules 110 and 120 of the equipment 100 matches said sharing request.

The transmitting unit 160 is connected to the data assigning unit 130, for transmitting feedback information to said other equipment that sends the sharing request, according to the judgment of the above-mentioned data assigning unit 150. Said transmitting unit 160 can also be used for transmitting the output data of the function sharing modules 100 and 120 to said other equipment that sends the sharing request or to other specified equipments.

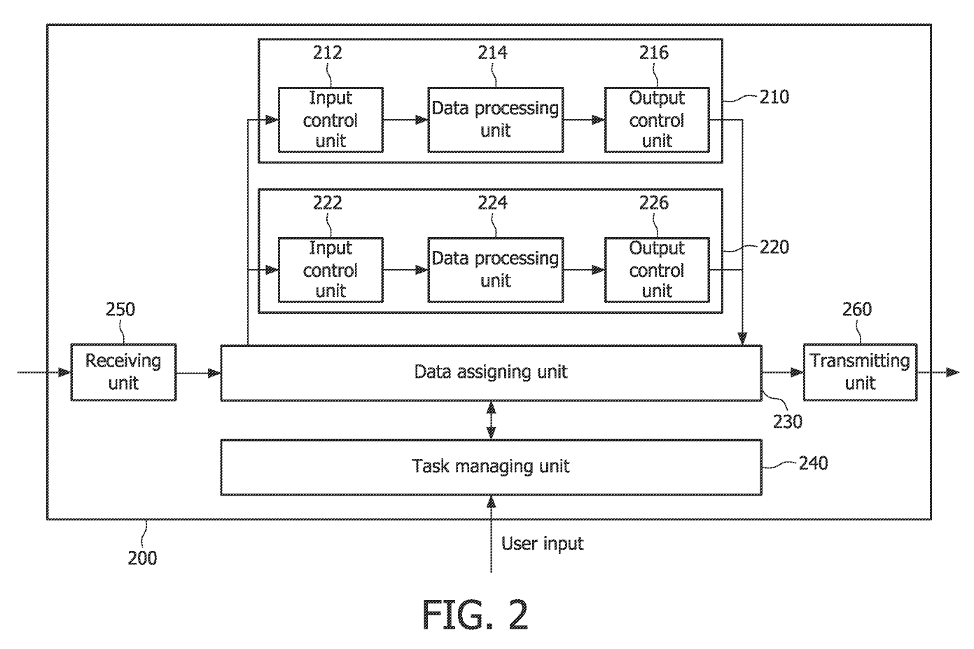

FIG. 2 is the schematic drawing of the structure of an equipment having function sharing module and task managing unit according to one embodiment of the present invention.

Said equipment 200 comprises a task managing unit 240 which can be used to receive the information input by a user and thus to arrange a specific task, for example, the user wants to play the music of MP3 format through a loudspeaker.

The task managing unit 240 can also be used to decompose said task into at least two sub-tasks; and to assign said at least two sub-tasks to at least two function modules so as to enable said at least two function modules to complete said at least two sub-tasks, respectively, wherein said at least two function modules respectively belong to at least two different equipments.

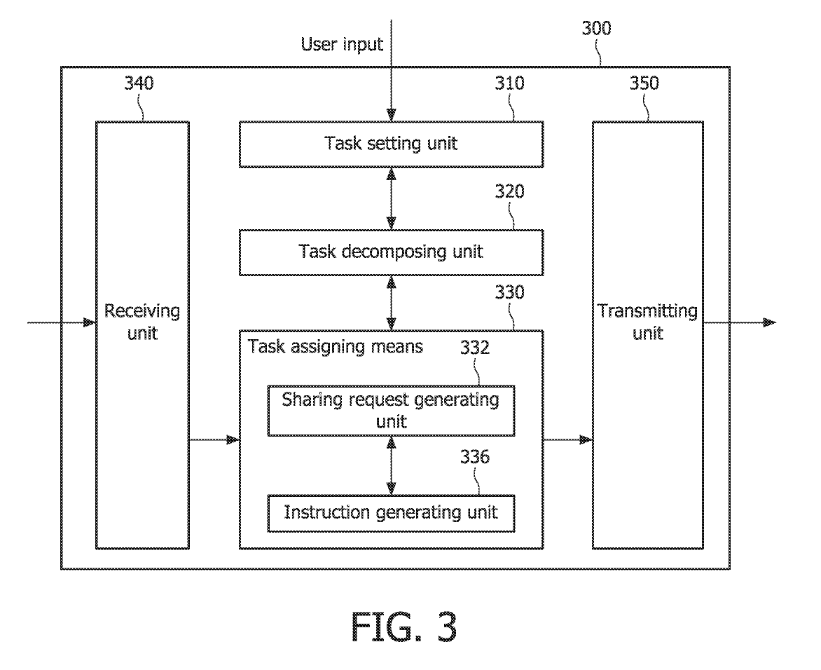

Said managing unit 240 can list the function combinations needed for completing said specific task, for example, playing a music of MP3 format through a loudspeaker needs MP3 decoding+loudspeaker, thus it will first be detected in equipment 200 itself whether there are said two functions so as to help the user to determine whether it is needed to share the available function sharing module on other equipments. The detailed illustrations of the functions of the task managing unit 240 could be seen in FIG. 3.

According to another embodiment of the present invention, the transmitting unit 260 can also be used to transmit a sharing request to other equipments according to a specific task set by the user in the managing unit 240, said sharing request includes task/sub-task description information. For example, the user sets a task in an MP3 player: playing a music of MP3 format through a loudspeaker, but according to the judgment of the data assigning unit 240, said MP3 player does not have the function of a loudspeaker, then the transmitting unit 260 could send a sharing request to other equipments to request sharing the available loudspeaker on other equipments, wherein said sharing request includes task/sub-task description information which includes at least the format description information of a decoded audio data.

According to another embodiment of the present invention, the receiving unit 250 could also be used to receive one or more pieces of feedback information sent back by other equipments in response to said sharing request. When a plurality of feedback information are received, it unit that a plurality of function sharing modules that match said sharing request are available, then the user could select one of them through the managing unit 240. Said feedback information can also indicate that the requested other equipments do not have the function sharing module that could execute the corresponding sub-task or the function sharing module that could execute the corresponding sub-task has been occupied (i.e., the present state is unavailable).

The other unit or modules shown in FIG. 2, such as the function sharing modules 210 and 220, and the data assigning unit 230, have the similar functions as the unit shown in FIG. 1, so they will not be described repetitively herein.

FIG. 3 is the schematic drawing of the structure of a task managing unit according to one embodiment of the present invention.

According to one embodiment of the present invention, said task managing unit 300 is used to receive the input information of a user so as to set a specific task. Those skilled in the art should understand that said task managing unit 300 could be a part of an equipment and be included in said equipment, such as the equipment 200 as shown in FIG. 2.

Said task managing unit 300 can also be an independent equipment for controlling the function sharing modules on other equipments so as to complete a specific task, for example, it can be used as a part of the server of a home network to manage the tasks in said home network. In this case, said server can include a function module list which includes all the sharable function sharing module information of different equipments in said home network, such as the names of the function sharing modules, the names of the equipments to which said function sharing modules belong, the network address thereof, the data input and output format information of said function sharing modules, and the available state, etc.

According to one embodiment of the present invention, said task managing unit 300 includes a task decomposing unit 320 and a task assigning unit 330.

Said task decomposing unit 320 is used to decompose the specific task set by a user into a plurality of sub-tasks. For example, the user sets a task of playing a file of RM (Real Media) format, then said task decomposing unit 320 can decompose said task into two sub-tasks, i.e., RM decoding and loudspeaking by the loudspeaker. Or else, said task decomposing unit 320 can also decompose said task into three sub-tasks, i.e., converting the RM format into MP3 format, MP3 decoding and loudspeaking by the loudspeaker.

Said task decomposing unit 320 can decompose a task according to a predetermined task decomposing list. Of course, said task decomposing unit 320 can also decompose a task according to the sharable function sharing module information that is available in the network, so that the task decomposing may be performed more efficiently. Said task decomposing list includes a plurality of pre-set task decomposing modes. When the user sets a task, said task decomposing unit 320 can match said task to the tasks pre-set in the task decomposing list and then to decompose said task.

Said task assigning unit 330 is used to assign said at least two sub-tasks to at least two function modules, so that said at least two function modules can respectively complete said at least two sub-tasks, wherein said at least two function modules respectively belong to at least two different equipments.

For example, the above-mentioned three sub-tasks, i.e., converting the RM format into MP3 format, MP3 decoding and loudspeaking by the loudspeaker, respectively correspond to three function modules, i.e., the format converting module, MP3 decoding module and loudspeaking module. Examples for them are format converting module from a computer, an MP3 decoding module from a DVD player, and the loudspeaking module from a television.

Said task assigning unit 330 includes a sharing request generating unit 332 and an instruction generating unit 336, wherein said sharing request generating unit 332 generates a sharing request to search for said at least two function modules, and wherein said sharing request includes the task description information corresponding to at least said two sub-tasks, said at least two function modules belong to at least more than two equipments; said instruction generating unit 336 is used for generating an instruction according to the feedback information to said sharing request, said instruction is used to instruct said at least two function modules to respectively execute said at least two sub-tasks. For example, said instruction includes relevant information like the address of a source file of the task to be executed, and the data input source address and data output address of each function sharing module, so that the at least two function modules could respectively complete said two sub-tasks orderly.

According to one embodiment of the present invention, said task managing unit 300 further comprises a transmitting unit 350 for transmitting the sharing request generated by said task assigning unit 330 so as to search the at least two function modules needed for completing said at least two sub-task. The manner of transmission could be broadcasting, such as broadcasting in wireless network and wired network.

According to another embodiment of the present invention, the manner of searching said at least two function modules can also be searching on a server, wherein the function list of all the relevant equipments is registered on said server. For instance, a home network server may include the function list of all the equipments of said home.

According to one embodiment of the present invention, said task managing unit 300 further comprises a receiving unit 340 for receiving the feedback information sent back by the other equipments in response to the sharing request.

According to one embodiment of the present invention, said task managing unit 300 further comprises a task setting unit 310 for receiving the information input by the user so as to set a specific task, such as playing a file of RM format.

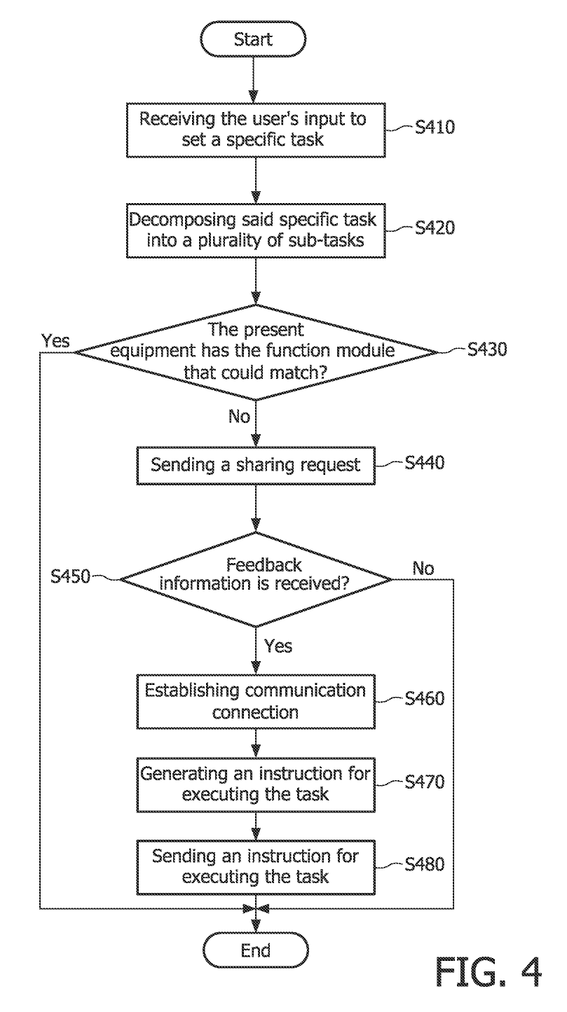

FIG. 4 is a flow chart of the method for a device to actively looking for the function sharing module according to one embodiment of the present invention. Said method flow chart can be applied to the equipment as shown in FIG. 2 that has function sharing module and task managing unit.

Firstly, in step S410, the input of a user is received so as to set a specific task. For example, the user wants to play music of MP3 format through a loudspeaker.

In step S420, said specific task is decomposed into at least two sub-tasks. For example, said task is decomposed into two sub-tasks of MP3 decoding and loudspeaking through the loudspeaker.

A task can be decomposed according to a pre-set task decomposing list. Said task decomposing list includes a plurality of pre-set task decomposing modes. When the user sets a task, said task is matched to the task and sub-task correspondence information pre-set in the task decomposing list so as to decompose it.

Meanwhile, each sub-task is assigned with a corresponding function module. For example, the above-mentioned two sub-tasks, i.e., MP3 decoding and loudspeaking by the loudspeaker, are respectively corresponding to two function modules, i.e., MP3 decoding module and loudspeaking module. Each function module corresponds to the description information of a function module at the same time.

In step S430, it is judged whether the present equipment has the matched function module. If it is found that the present equipment includes all the function modules that could complete the sub-task, then the whole flow is ended without performing any function sharing.

If it is found that the present equipment does not have all the function modules for completing the sub-task, for example, the user sets a task of playing the music through a loudspeaker in an MP3 player, but after judging, it is found that said MP3 player does not have the function of a loudspeaker, then in step S440, a sharing request is generated according to the set task and is sent to other equipments. Wherein said sharing request includes a sub-task description information for searching for available function sharing module on other equipments.

For instance, the sub-task description information for MP3 decoding may include function request (decoding MP3), input format of the data to be processed (encoded MP3 format), output format of the data to be processed (decoded MP3 format), etc.

In step S450, it is judged whether one or more pieces of feedback information sent back by other equipments in response to said sharing request are received.

If no feedback information sent by other equipment is received, it unit that there is no available function sharing module, and a prompting message can be displayed to inform the user that the task cannot be carried out, and the whole flow is ended then.

If feedback information from other equipment is received, then communication link to said equipment is established in step S460, for example, using UWB (Ultra Wide-Band) mode to establish the communication link. Said connection process can include an authority validation process, for example, validate the PIN code when performing connection “match”.

After the connection is established, an instruction is generated according to the feedback information to said sharing request in step S470, said instruction is used to instruct said at least two function modules (MP3 decoder+loudspeaking) to execute said at least two sub-tasks (MP3 decoding+loudspeaking), respectively. For instance, said instruction includes relevant information like the address of a source file of the task to be executed and the data input source address and data output address of each function sharing module, so that at least two function modules could respectively complete said two sub-tasks orderly.

In step S480, corresponding instructions are begin to be sent to the present equipment and/or other equipments so as to use the function module of the present equipment and/or the corresponding function sharing module of another equipment to process the data and to complete the at least two sub-tasks, and finally, the whole flow is ended.

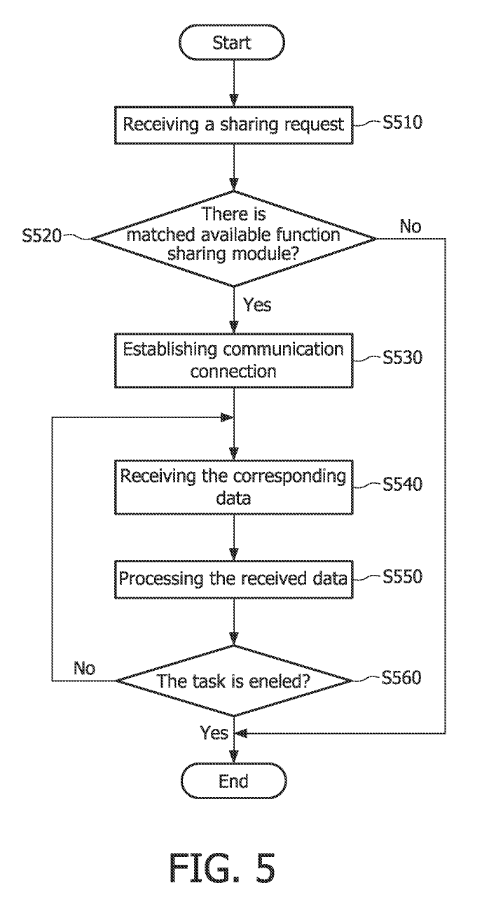

FIG. 5. is a flow chart of the method for a device to passively receive the request for function sharing according to one embodiment of the present invention. Said method flow chart can be applied to the equipment having function sharing module as shown in FIG. 1.

Firstly, in step S510, a sharing request from other equipments is received, said sharing request include a sub-task description information so as to judge, according to said task/sub-task description information, whether the data processing function of the function sharing module of said equipment matches said sharing request. Wherein said task/sub-task description information at least includes the format data of the data to be processed.

When a sharing request is received, it is judged in step S520 whether a function sharing module that matches the sub-task description information exists. For example, it is judged whether the function sharing module matches the received sharing request according to a list of all the available function sharing modules in said equipment, said list includes information like the names, the description information of input data format, the description information of output data format of the function sharing modules.

If the function sharing module that matches said output format exists, then communication link is established with the other equipment that sends the sharing request in step S530, the process of establishing the connection corresponds to the step S460 in FIG. 4, and it will not be detailed herein any more.

After the connection is established, in step S540, data from other equipments that send the sharing requests are begin to be received, then in step S550, the available function sharing module is used to process said data.

Finally, it is judged whether the task is completed in step S560. If the task is completed, the whole flow is ended, while if the task is not completed yet, returns to step S540 to continue receiving data of corresponding format.

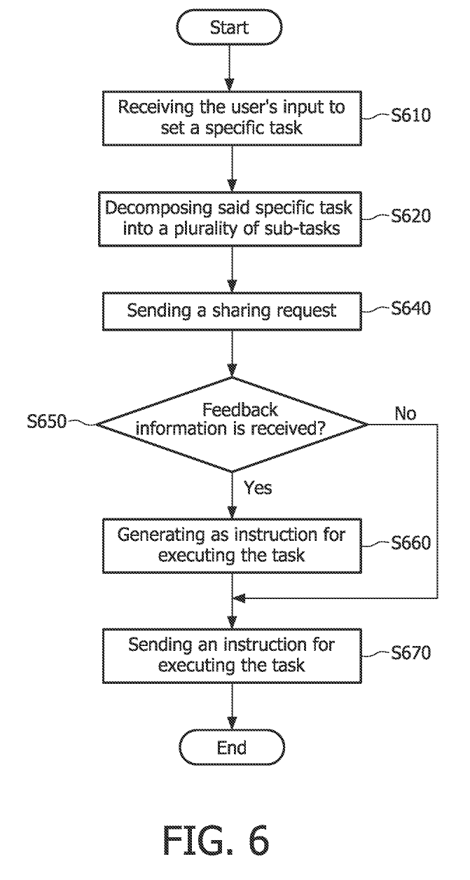

FIG. 6 is a flow chart of the method for a task managing unit to look for the function sharing module so as to complete a task according to one embodiment of the present invention. Said method flow chart can be applied to the equipment having a task managing unit as shown in FIG. 3.

Firstly, the input of a user is received to set a specific task in step S610. for example, the user sets a task of playing a file of RM format.

In step S620, said specific task is decomposed into a plurality of sub-tasks, for example, said task is decomposed into two sub-tasks of RM decoding and loudspeaking by the loudspeaker. Or else, said task decomposing unit 320 can also decompose said task into three sub-tasks, i.e., converting the RM format into MP3 format, MP3 decoding and loudspeaking by the loudspeaker.

A task can be decomposed according to a predetermined task decomposing list. Said task decomposing list includes of a plurality of pre-set task decomposing modes. When the user sets a task, said task is matched to the tasks pre-set in the task decomposing list and then to decompose it.

Each sub-task has a corresponding sub-task description information. For instance, the sub-task description information for converting RM format into MP3 format may include function request (for converting RM format into MP3 format), input format of the data to be processed (RM format), output format of the data to be processed (MP3 format), etc.

In step S640, a sharing request is sent which includes the sub-task description information corresponding to each of said sub-tasks. Said sub-task description information includes of the function request of said sub-task, the input format of the data to be processed, and the output format of the data to be processed, etc. The manner of sending sharing request could be broadcasting, such as broadcasting in wireless network and wired network.

In step S650, it is judged whether feedback information sent by other equipments is received. The function of said three function modules may be achieved by combining different equipments. For example, format converting module from a computer, an MP3 decoding module from a DVD player, and the loudspeaking module from a television. If feedback information from said three equipments is received, then it unit that each sub-task has had an available function module.

After establishing the connection, an instruction is generated according to the feedback information to said sharing request in step S660, said instruction is used to instruct said three function modules (e.g., the format converting module+MP3 decoder+loudspeaker) to respectively execute said three sub-tasks (e.g., converting the RM format into MP3 format+MP3 decoding+loudspeaking). Said instruction includes relevant information like the address of a source file of the task to be executed, and the data input source address and data output address of each function sharing module, so that said at least three function modules could respectively complete said three sub-tasks orderly.

In step S670, corresponding instructions are begin to be sent to other equipments, so that the corresponding function sharing modules on said other equipments can be used to process data and to complete at least three sub-tasks. Finally, the whole flow is ended.

Those skilled in the art should understand that the equipment having function sharing modules and the method of implementing it as disclosed in the present invention can be improved in various ways without deviating from the contents of the present invention, so the protection scope of the invention should be defined by the attached claims.

1. A method of managing a task, including the steps of
(a) decomposing said task into at least two sub-tasks;
(b) assigning said at least two sub-tasks to at least two function modules, so that said at least two function modules respectively complete said at least two sub-tasks, wherein said at least two function modules respectively belong to at least two different equipments.

2. The method according to claim 1, wherein step (a) includes the step of decomposing said task into at least two sub-tasks according to a task decomposing list, wherein said task decomposing list includes the comparison information between said task and said at least two sub-tasks.

3. The method according to claim 1, wherein step (b) includes the steps of generating a sharing request to search for said at least two function modules, said sharing request including the task description information corresponding to said at least two sub-tasks, and said at least two function modules belong to at least more than two equipments; and generating an instruction according to the feedback information to said sharing request, said instruction being used to instruct said at least two function modules to respectively execute said at least two sub-tasks.

4. The method according to claim 3, further including the step of sending said instruction to said at least two function modules.

5. The method according to claim 1, further including the step of receiving a user's input information to set said task.

6. An apparatus for managing a task, comprising:
a task decomposing means for decomposing said task into at least two sub-tasks;
a task assigning means for assigning said at least two sub-tasks to said at least two function modules so as to make said at least two function modules respectively complete said at least two sub-tasks, wherein said at least two function modules respectively belonging to at least two different equipments.

7. The apparatus according to claim 6, wherein said task decomposing means is used for decomposing said task into at least two sub-tasks according to a task decomposing list, and wherein said task decomposing list includes the comparison information between said task and said at least two sub-tasks.

8. The apparatus according to claim 6, wherein the task assigning means comprises:
a sharing request generating means for generating a sharing request to search for said at least two function modules, wherein said sharing request includes the task description information corresponding to said at least two sub-tasks, and said at least two function modules belong to at least more than two equipments; and
an instruction generating means for generating an instruction according to the feedback information to said sharing request, said instruction is used to instruct said at least two function modules to respectively execute said at least two sub-tasks.

9. The apparatus according to claim 8, further comprising a transmitting means for transmitting said instruction to said at least two function modules.

10. The apparatus according to claim 6, further comprising a receiving means for receiving the input information of a user to set said task.
